(19) United States
(12) Patent Application Publication
(10) Pub. No.: US 2019/0010093 A1
(43) Pub. Date: Jan. 10, 2019

(54) MINERAL FERTILIZER

(71) Applicants: Genowefa Henryka LASKOWSKA, Kikól (PL); Marian Boguslaw INSADOWSKI, Chorzów (PL)

(72) Inventors: Genowefa Henryka LASKOWSKA, Kikól (PL); Marian Boguslaw INSADOWSKI, Chorzów (PL)

(21) Appl. No.: 16/080,295

(22) PCT Filed: Feb. 29, 2016
(86) PCT No.: PCT/PL2016/000020

§ 371 Date: Aug. 27, 2018

(51) Int. Cl. C05B 17/00; C05D 5/00; C05D 3/02; C05D 9/00; C05B 19/00

(52) U.S. Cl. CPC C05B 17/00; C05D 5/00; C05B 19/00; C05D 9/00; C05D 3/02

(57) ABSTRACT

The invention relates to a mineral fertilizer. The minetral fertilizer is a mixture comprising: a) at least one crushed volcanic rock with SiO₂ content <44%, grain size 0.00 mm-2.00 mm, selected from a group comprising: dunite, lamprophyres, peridotite, in the amount of from 5 to 95% by weight, and at least one crushed sedimentary rock, grain size 0.00 mm-2.00 mm, selected from a group comprising dolomite, bentonite, zeolite, phosphorite, magnesite, potassium salts, diatomaceous earth, in the amount of from 5 to 95% by weight, and/or b) at least one crushed volcanic rock with SiO₂ content of from 44%-53%, grain size 0.00 mm-2.00 mm, selected from a group comprising trachybasalt—melaphyre, porphyry—rhyolite, andesite, latite, gabbro, pyroxenite, obsidian, spilite, diabase in the amount from 5 to 95% by weight and at least one crushed sedimentary rock, grain size 0.00 mm-2.00 mm, selected from a group comprising dolomite, bentonite, zeolite, phosphorite, magnesite, potassium salts, diatomaceous earth, in the amount of from 5 to 95% by weight, and/or c) at least one crushed volcanic rock with Si02 content of from 54%-65%, grain size 0.00 mm-2.00 mm, selected from a group comprising trachybasalt—including monzonite, diorite, syenite in the amount of 5 to 95% by weight and at least one crushed sedimentary rock, grain size 0.00 mm-2.00 mm, selected from a group comprising dolomite, bentonite, zeolite, phosphorite, magnesite, potassium salts, diatomaceous earth, in the amount of 5 to 95% by weight, and/or d) at least one crushed volcanic rock with SiO₂ content >65%, grain size 0.00 mm-2.00 mm, selected from a group comprising: granite, pegmatite, granodiorite, granitoids, carbonatites, dacite, tonalite, tuff-stone in the amount of from 5 to 95% by weight, and at least one crushed sedimentary rock, grain size 0.00 mm-2.00 mm, selected from a group comprising dolomite, bentonite, zeolite, phosphorite, magnesite, potassium salts, diatomaceous earth in the amount of from 5 to 95% by weight.

The invention relates to a volcanic rock mineral fertilizer, particularly for use to support the growth of plants and change soil characteristics.

The publication of British patent application GB 2 141 419 A discloses a fertilizer composition comprising the product from the desalting, by means of sulphuric acid and in the presence of an organic solvent, of an effluent from an industrial fermentation of sugar, and at least one organic or inorganic material containing phosphorus and nitrogen; the composition having a total nitrogen content of not less than 1.5% by weight, a phosphorus content (expressed as P₂O₅) of not less than 4% by weight, a potassium content (expressed as K₂O) of not less than 5% by weight, and an organic carbon content of not less than 8% by weight.

From the publication of international patent application WO 2014/0080352 A1 there is known a fertilizer composition comprising granules, the granules comprising urea and a plant hormone such as gibberellic acid (GA₃) or salts thereof with density of from 0.5 g/cm⁸ to 1.5 g/cm³ or have a mean particle diameter of from 1 mm to 5 mm or have a particle size distribution whereby at least 90% of the granules have a diameter of from 1 mm to 5 mm, or have a particle size distribution whereby at least 90% of the granules have a diameter within 1 mm have a hardness of from 10 N to about 70 N and comprise less than 0.5% of the plant hormone or any combination of two or more plant hormones.

From the publication of an international patent application WO 2015/010203 there is known a fertilizer containing from about 0.5 to about 1 part Mg, from about 2.4 to about 2.8 parts P₂O₅, from about 1.4 to about 2.8 parts Zn being a fine powder mixture, a granular mixture or a liquid solution or suspension.

From the international patent application WO92/00940 there is known a method of enhancing the growth of plants in a soil or soil-like medium during a growing period in which a composition comprising ammonia nitrogen, nitrate nitrogen and at least one trace element is periodically added to the growing medium, and the ratio of ammonia nitrogen to nitrate nitrogen is adjusted during the growing period and maintained constant to the content by weight of the trace element during the entire growing period.

Also from the publication of an international patent application WO 2012/070955 A1 there is known a fertilizer comprising phosphate rock of less than 500 μm making up from 60% to 80% of the fertilizer, sulphur making up 5% to 12%, carbon or coal, 75% of which has a particle size of less than 350 μm and approximately all of the coal has a particle size of less than 1 mm, humic acid and/or fulvic acid and a suitable binder selected from a group comprising sugar, starch or a suitable clay, ora combination of these.

From Polish patent PL212219 B1 there is known a method of producing granulated calcium and magnesium fertilizer wherein output being limestone containing magnesium is fed to the granulation machine with a conveyor, binding material being gypsum is fed to the conveyor by a feeder and then the total weight is fed to a drum of the granulation machine where the granulation process is divided into three stages: the first stage involves thorough mixing of components, the second stage involves preliminary granulation and at the third stage fine magnesium lime is added to the pre-granulated fertilizer, spherical granules are produced which are later dried and sorted.

There is also known from Polish patent PL192888 B1 a composition of a multi-compound granulated fertilizer and a production method thereof. The fertilizer contains triple superphosphate containing 46% P in the amount of from 15 to 30 parts by weight, most preferably 17.33 parts by weight, urea containing 46% N in the amount of from 10 to 37 parts by weight, most preferably 18 parts by weight, a substance of plant origin in form of a mineral compound generated during the burning of beet pulp, being the source of potassium, calcium, and microelements in the amount of from 30 to 60 parts by weight, most preferably 51.42 parts by weight, magnesium sulfate containing 21% MgO in the amount of from 5 to 10 parts by weight, most preferably 7 parts by weight, and bentonite in the amount of from 5 to 10 parts by weight, most preferably 6.25 parts by weight. The method of producing the fertilizer wherein a mixture of triple superphosphate containing 46% P in the amount of from 15 to 30 parts by weight, most preferably 17.33 parts by weight, urea containing 46% N in the amount of from 10 to 37 parts by weight, most preferably 51.42 parts by weight, a substance of plant origin in form of a mineral compound generated by burning beet pulp, being the source of potassium, calcium and microelements in the amount of from 30 to 60 parts by weight, most preferably 51.42 parts by weight, magnesium sulfate containing 21% MgO in the amount of from 5 to 10 parts by weight, most preferably 7 parts by weight, and bentonite in the amount of from 5 to 10 parts by weight, most preferably 6.25 parts by weight is crushed to powder and granulated on a rotating granulation container positioned obliquely, simultaneously preferably from 8 to 12 parts by weight are moistened with water to achieve humidity, once dry, the granules are screened, the final product being fractions from 2 mm to 4 mm.

Polish patent PL193634 discloses the composition of an organic fertilizer comprising a mixture of organic components of animal and plant origin and contains bone meal in the amount of 10.90% of the weight, meat and bone meal in the amount of 0.80% of weight, feather meal or eggshell meal, as well as brown coal or dry peat in the amount of 10.70% of the weight, the mixture enriched with calcium propionate-based anti-fungal and anti-mildew substance according to patent PL 188049.

Volcanic rock mining and output processing, especially the production of breakstone used for road building, generate considerable amounts of waste rock material of different size comprising:
ultra-basic volcanic rock—SiO₂ content <44%, comprising dunite, lamprophyres, peridotite;
basic volcanic rocks—SiO₂ content from 44% to 53%, comprising trachybasalt—melaphyre, porphyry—rhyolite, andesite, latite, gabbro, pyroxenite, obsidian, spilite, diabase;
neutral volcanic rocks—SiO₂ content from 54% to 65%, comprising monzonite, diorite, syenite,
acidic volcanic rocks—SiO₂ content >65%, granite, pegmatite, granodiorite, granitoids, carbonatites, dacite, tonalite, tuff-stone,

It was found that this material has properties which make it possible to use it as a valuable component of mineral fertilizers.

It was also found that even the finest particles of this crushed material have, in most cases, a glassy fracture and sharp uneven edges which with minute particles, grain diameter below 0.07 mm, may cause damage and clogging of spiracles in insects' respiratory systems.

Mineral fertilizer according to the invention is a mixture comprising:
a) at least one crushed volcanic rock with SiO₂ content <44%, grain size from 0.00 mm-2.00 mm, selected from a group comprising: dunite, lamprophyres, peridotite, in the amount of from 5 to 95% by weight and at least on crushed sedimentary rock with grain size from 0.00 mm-2.00 mm, selected from a group comprising dolomite, bentonite, zeolite, phosphorite, magnesite, potassium salts, diatomaceous earth in the amount of from 5 to 95% by weight, and/or
b) at least one crushed volcanic rock with SiO₂ content from 44% to 53%, grain size 0.00 mm-2.00 mm, selected from a group comprising trachybasalt—melaphyre, porphyry—rhyolite, andesite, latite, gabbro, pyroxenite, obsidian, spilite, diabase in the amount of from 5 to 95% by weight and at least one crushed sedimentary rock with grain size of 0.00 mm-2.00 mm, selected from a group comprising dolomite, bentonite, zeolite, phosphorite, magnesite, potassium salts, diatomaceous earth in the amount of from 5 to 95% by weight and/or
c) at least one crushed volcanic rock with SiO₂ content from 54%-65%, grain size 0.00 mm-2.00 mm, selected from a group comprising trachybasalt—monzonite, diorite, syenite in the amount of from 5 to 95% by weight and at least one sedimentary rock, grain size 0.00 mm-2.00 mm, selected from a group comprising dolomite, bentonite, zeolite, phosphorite, magnesite, potassium salts, diatomaceous earth in the amount of from 5 to 95% by weight, and/or
d) at least one crushed volcanic rock with SiO₂ content >65%, grain size 0.00 mm-2.00 mm, selected from a group comprising: granite, pegmatite, granodiorite, granitoids, carbonatites, dacite, tonalite, tuff-stone in the amount of from 5 to 95% by weight, and at least one crushed sedimentary rock, grain size 0.00 mm-2.00 mm, selected from a group comprising dolomite, bentonite, zeolite, phosphorite, magnesite, potassium salts, diatomaceous earth in the amount of from 5 to 95% by weight.

It is preferred that the fertilizer according to the invention contains an addition of crushed sulphur, particle size from 0.00-2.00 mm in the amount of up to 5% by weight. A small addition of sulphur enhances the growth of plants and increases the fertilizer efficiency.

To keep the insecticidal properties, it is preferred that the fertilizer according to the invention contains at least 30% by weight of volcanic rock fractions, grain size from 0.00 to 0.07 mm.

To prevent the dusting, it is preferred when the fertilizer according to the invention is a granulated product containing up to 2% by weight of a binder selected from a group comprising sugar molasses, cane molasses, polysaccharides, particularly corn starch, cellulose, modified cellulose.

The fertilizer according to the invention is produced by mixing crushed and sifted components.

Tables 1 and 2 below show exemplary compositions of the mineral fertilizer according to the invention.

TABLE 1

| Component [% by weight] | I | II | III | IV | V | VI |
|---|---|---|---|---|---|---|
| Volcanic rock with SiO₂ | 80 | 70 | 50 | 65 | 75 | 94 |
| content <44% | | | | | | |
| Ground phosphate rock | — | 15 | 15 | 15 | | — |
| Magnesite meal | — | — | 15 | 15 | 25 | — |
| Potassium meal | — | — | — | — | — | — |
| Dolomite | 20 | 15 | 20 | — | — | — |
| Bentonite | — | — | — | — | — | 2 |
| Zeolite | — | — | — | — | — | 2 |
| Diatomaceous earth | — | — | — | — | — | 2 |
| Sulphur | — | — | — | 5 | — | — |

TABLE 2

| Component [% by weight] | VII | VIII | IX | X | XI | XII | XIII |
|---|---|---|---|---|---|---|---|
| Volcanic rock with SiO₂ | — | 50 | — | — | 40 | — | — |
| content <44% | | | | | | | |
| Volcanic rock with SiO₂ | 70 | 50 | — | — | — | 90 | — |
| content from 44%-53%% | | | | | | | |
| Volcanic rock with SiO₂ | 50 | — | 50 | — | 40 | — | — |
| content from 54%-65%, | | | | | | | |
| Volcanic rock with SiO₂ | — | — | — | 90 | — | — | 65 |
| content >65% | | | | | | | |
| Ground phosphate rock | — | — | 15 | 5 | 15 | — | — |
| Magnesite meal | — | — | 10 | — | — | — | 10 |
| Potassium meal | 10 | — | 15 | 5 | 5 | 2 | 5 |
| Dolomite | 20 | — | — | — | — | — | — |
| Bentonite | — | — | — | — | — | 2 | — |
| Zeolite | — | — | 5 | — | — | 2 | 10 |
| Diatomaceous earth | — | — | — | — | — | 2 | — |
| Sulphur | — | — | 5 | — | — | 2 | — |

Mineral fertilizer according to the invention comprises: SiO₂ from 40.08 to 72.40% by weight, Al₂O₃ up to 14.40% by weight, TiO₂ up to 2.38% by weight, Fe₂O₃ up to 13.43% by weight, MgO up to 12.40% by weight, MnO up to 0.13% by weight, Na₂O up to 3.85% by weight, K₂O up to 3.81% by weight, P₂O₅ up to 8.00% by weight, SO₃ up to 0.12% by weight, Cl up to 0.66% by weight. Furthermore, the fertilizer contains trace quantities of microelements such as copper, zinc, molybdenum, bromine, chromium, vanadium, lithium, nickel.

Since the fertilizer according to the invention has the tendency to dust, it is preferred that the fertilizer according to the invention has the form of a granulated product. To obtain the fertilizer according to the invention in form of a granulated mixture of components, the components mixed with a binder and an appropriate amount of water are granulated in a granulator in higher temperature ranging from 60-70° C.

Below are exemplary mixtures subject to granulation, and granulation conditions thereof:
1. Volcanic rock meal, fraction 0.00 mm to 2.00 mm −85% by weight,
   bentonite, fraction 0.00 mm to 2.00 mm −3% by weight,
   sugar molasses −2% by weight,
   water at the temperature of 60-70 degrees Celsius −10% by weight,
   mixing and granulation performed in the granulator until the product obtains its granulated form
2. Volcanic rock meal, fraction 0.00 mm-2.0 mm, −85% by weight, bentonite,
   fractions 0.00 mm-2.0 mm, −3% by weight,
   sugar molasses 2% by weight,
   water at the temperature of 60-70° C., −10% by weight,
   mixing and granulation performed in the granulator until the product obtains its granulated form.
3. Volcanic rock meal, fraction 0.00 mm-2.00 mm, −70% by weight,
   dolomite, fraction 0.00 mm-2.00 mm, −15% by weight,
   bentonite, fraction 0.00 mm-2.00 mm, −3% by weight,
   starch −2% by weight,
   water at the temperature of 60-70° C., −10% by weight,
   mixing and granulation performed in the granulator until the product obtains its granulated form.
4. Volcanic rock meal, fraction 0.00 mm-2.00 mm, −55% by weight,
   ground phosphate rock, fraction 0.00 mm-2.00 mm, −15% by weight,
   dolomite, fraction 0.00 mm-2.00 mm, −15% by weight,
   bentonite, fraction 0.00 mm-2.00 mm, 3% by weight,
   cane molasses in the amount of 2% by weight,
   water at the temperature of 60-70 ° C., −10% by weight,
   mixing and granulation performed in the granulator until the product obtains its granulated form.
5. Volcanic rock meal, fraction 0.00 mm-2.00 mm, −50% by weight,
   ground phosphate rock, fraction 0.00 mm-2.00 mm, −15% by weight,
   magnesite meal, fraction 0.00 mm-2.00 mm, −15% by weight,
   dolomite meal, fraction 0.00 mm-2.00 mm, −5% by weight,
   bentonite, fraction 0.00 mm-2.00 mm, −3% by weight,
   sugar molasses −2% by weight,
   water at the temperature of 60-70° C., −10% by weight
6. Volcanic rock meal, fraction 0.00 mm-2.00 mm, −50% by weight,
   ground phosphate rock, fraction 0.00 mm-2.00 mm, −15% by weight,
   magnesite meal, fraction 0.00 mm-2.00 mm, −15% by weight,
   sulphur, fraction 0.00 mm-2.00 mm, −5% by weight,
   bentonite, fraction 0.00 mm-2.00 mm, −3% by weight,
   modified cellulose −2% by weight,
   water at the temperature of 60-70 degrees Celsius −10% by weight.
7. Volcanic rock meal, fraction 0.00 mm-2.0 mm, −81% by weight,
   zeolite meal, fraction 0.00 mm-2.00 mm, −2% by weight,
   diatomaceous earth, fraction 0.00 mm-2.00 mm, −2% by weight,
   bentonite meal, fraction 0.00 mm-2.00 mm, −3% by weight,
   sugar molasses, −2% by weight,
   water at the temperature of 60-70 degrees Celsius, −10% by weight.

The best agricultural results are obtained when the mineral fertilizer according to the invention is applied in the amount of from 1 to 5 tons per each hectare of land, or from 5 to 10 kg per 100 kg of compost, or from 1 to 5 kg per each 10 m². The fertilizer according to the invention may also be used in form of water slurries, with the above-mentioned proportions maintained.

To control pests such as aphids, caterpillars, beetles, potato beetle and snails, it is recommended to dust plants with the fertilizer according to the invention in form a mechanically dispersed powder.

The mineral fertilizer according to the invention increases the resistance of plants, trees and shrubs to diseases and supports control of diseases such as potato blight, fire blight, bacterial canker, bacterial blotch, grey mould, curl virus, scab, powdery mildew and mildew.

The fertilizer according to the invention ensures gradual and long-term supply of necessary macro and microelements to plants. The fertilizer has a practically unlimited storage period.

The following soil mixtures were prepared using the fertilizer according to the invention:
1. Mineral fertilizer according to the invention, composition according to table 1, was mixed with peat at the ratio of 5-10 kg of the fertilizer per 100 kg of peat.
2. Mineral fertilizer according to the invention, composition according to table 2, was mixed with humus at the ratio of 5-10 kg of meal per 100 kg of humus,
   the mixtures were subject to agricultural testing wherein the results obtained were compared with results obtained on comparable blank samples to which the fertilizer according to the invention was not applied.

In both cases tests showed that the fertilizer according to the invention has a stimulating effect on the growth of aerobic microbes and at the same time inhibits the growth of anaerobic microbes which is very advantageous for the composting process. Tests confirmed that in both cases plants' resistance to diseases increased and the fertilizer enhanced the growth of plants' roots, and facilitated a continuous steady growth of plants.

Mineral fertilizer according to the invention is a fertilizer based fully on natural components, it is environmentally-friendly, and does not contaminate the soil or water. The fertilizer according to the invention enhances the growth of plants and improves soil structure, enriches light soil with minerals necessary for the crops to grow, regulates soil mineral balance—improves soil pH, increases plants' resistance to diseases, increases the growth of plant and tree roots, has a positive impact on crops growth. The fertilizer according to the invention does not require a waiting period after its use, and there is no possibility of overusing the fertilizer.

The fertilizer according to the invention has fungicidal effects on fungi attacking plants, it also enhances the growth of aerobic microbes and inhibits the growth of anaerobic microbes thus enhancing the composting process. The fertilizer according to the invention, used as an additive, binds ammonia in liquid manure and manure and at the same time enriches the manure with minerals. Fine fractions of volcanic rock particles included in the composition of the fertilizer according to the invention get in the respiratory systems of insects feeding on plants and block and damage their spiracles and thus the fertilizer is also an insecticide as it makes it impossible for the insects to breathe.

The fertilizer according to the invention may be used as a natural seed dressing. The fertilizer makes stems grow and harden, increases plant resistance to stress, regulates assimilation processes and improves plants vigor. Minerals present in the fertilizer according to the invention and absorbed by plants, vegetables and fruit are a valuable source of microelements for people and animals who consume them.

The fertilizer according to the invention may be used in agriculture, fruit culture, vegetable production, horticulture and cultivation of ornamental plants, for fertilizing fields, meadows, forests, lawns, areas surrounding buildings and green areas, and to enrich and change the mechanical properties of soil.

1. Mineral fertilizer comprising crushed phosphorite, and minerals comprising magnesium oxide and calcium oxide characterized in that it is a mixture comprising:
a) at least one crushed volcanic rock with SiO₂ content <44%, grain size 0.00 mm-2.00 mm, selected from a group comprising: dunite, lamprophyres, peridotite, in the amount of from 5 to 95% by weight, and at least one crushed sedimentary rock, grain size 0.00 mm-2.00 mm, selected from a group comprising dolomite, bentonite, zeolite, phosphorite, magnesite, potassium salts, diatomaceous earth, in the amount of from 5 to 95% by weight, and/or
b) at least one crushed volcanic rock with SiO₂ content of from 44%-53%, grain size 0.00 mm-2.00 mm, selected from a group comprising trachybasalt—melaphyre, porphyry—rhyolite, andesite, latite, gabbro, pyroxenite, obsidian, spilite, diabase in the amount from 5 to 95% by weight and at least one crushed sedimentary rock, grain size 0.00 mm-2.00 mm, selected from a group comprising dolomite, bentonite, zeolite, phosphorite, magnesite, potassium salts, diatomaceous earth, in the amount of from 5 to 95% by weight, and/or
c) at least one crushed volcanic rock with SiO₂ content of from 54%-65%, grain size 0.00 mm-2.00 mm, selected from a group comprising trachybasalt—including monzonite, diorite, syenite in the amount of 5 to 95% by weight and at least one crushed sedimentary rock, grain size 0.00 mm-2.00 mm, selected from a group comprising dolomite, bentonite, zeolite, phosphorite, magnesite, potassium salts, diatomaceous earth, in the amount of 5 to 95% by weight, and/or
d) at least one crushed volcanic rock with SiO₂ content >65%, grain size 0.00 mm-2.00 mm, selected from a group comprising: granite, pegmatite, granodiorite, granitoids, carbonatites, dacite, tonalite, tuff-stone in the amount of from 5 to 95% by weight, and at least one crushed sedimentary rock, grain size 0.00 mm-2.00 mm, selected from a group comprising dolomite, bentonite, zeolite, phosphorite, magnesite, potassium salts, diatomaceous earth in the amount of from 5 to 95% by weight.

2. Fertilizer according to claim 1, characterized in that it contains an addition of crushed sulphur, particle size of 0.00-2.00 mm in the amount of 5% by weight.

3. Fertilizer according to claim 1, characterized in that it contains at least 30% by weight of fraction with grain size 0.00 to 0.08 mm.

4. Fertilizer according to claim 1, characterized in that it has a granulated form containing up to 2% by weight of a binder selected from a group comprising sugar molasses, cane molasses, polysaccharides, and in particular corn starch, cellulose, modified cellulose.
